(19) United States
(12) Patent Application Publication
(10) Pub. No.: US 2024/0332554 A1
(43) Pub. Date: Oct. 3, 2024

(54) CARBON MATERIAL FOR CATALYST SUPPORT AND METHOD FOR MANUFACTURING CARBON MATERIAL FOR CATALYST SUPPORT

(71) Applicants: Nobuyuki NISHI, Ishikawa (JP); TOYOTA BOSHOKU KABUSHIKI KAISHA, Aichi-ken (JP); AICHI UNIVERSITY OF EDUCATION, Aichi (JP)

(72) Inventors: Junko OHIRA, Kariya-shi (JP); Tomotaka SAITO, Kariya-shi (JP); Hiroshi YANO, Kariya-shi (JP); Kazuyuki HINO, Nagoya-shi (JP); Nobuyuki NISHI, Kanazawa-shi (JP)

(73) Assignees: Nobuyuki NISHI, Ishikawa (JP); TOYOTA BOSHOKU KABUSHIKI KAISHA, Aichi-ken (JP); AICHI UNIVERSITY OF EDUCATION, Aichi (JP)

(21) Appl. No.: 18/615,024

(22) Filed: Mar. 25, 2024

(30) Foreign Application Priority Data
Mar. 28, 2023 (JP) 2023-052314
Mar. 21, 2024 (JP) 2024-045333

(51) Int. Cl. H01M 4/92; C01B 32/184; H01M 8/10

(52) U.S. Cl. CPC H01M 4/926; C01B 32/184; C01B 2204/04; C01B 2204/32; C01P 2004/03; C01P 2004/04; C01P 2006/12; C01P 2006/14; C01P 2006/16; H01M 2008/1095

(57) ABSTRACT

A carbon material for catalyst support includes elongated carbon mesoporous structures containing graphene. The carbon mesoporous structures each have a major axis in a range of 50 nm to 200 nm and a minor axis in a range of 30 nm to 100 nm. Pore diameters and a cumulative pore volume determined through analysis of a nitrogen adsorption isotherm using a Dollimore-Heal method are respectively in a range of 1 nm to 20 nm and in a range of 1.5 cc/g to 2.5 cc/g.

### BACKGROUND

### 1. Field

The present disclosure relates to a carbon material for catalyst support and a method for producing the same.

### 2. Description of Related Art

For example, Japanese Patent No. 6198810 discloses a carbon material for catalyst support and a method for producing the same.

The carbon material described in this publication includes dendritic nanostructures of carbon (referred to as mesoporous carbon nanodendrites). The carbon material is obtained through a phase separation reaction after synthesizing silver acetylide. First, acetylene gas is introduced into an aqueous ammonia solution of silver nitrate while the solution is irradiated with ultrasonic waves, so that silver acetylide is produced as precipitate. After moisture is separated from the precipitate of silver acetylide, a heating treatment is performed in a vacuum atmosphere at a temperature in a range of 60° C. to 80° C. for a period longer than or equal to twelve hours. This causes segregation of the silver acetylide, resulting in the formation of metal-incorporating dendritic nanostructures containing metallic silver particles. If the precipitate is completely dried, it becomes unstable and may exhibit an explosive reaction due to frictional stimulation or the like.

The precipitate of silver acetylide is then heated to a temperature in a range of 160° C. to 200° C. At around 150° C., silver acetylide undergoes an explosive phase separation reaction, causing the incorporated silver to be ejected. This results in the formation of carbon dendritic nanostructures with numerous ejection pores (mesopores) on the surface and inside.

Since the carbon material in the above-described publication includes dendritic nanostructures, gases and other substances tend to be retained in the pores. There is thus a demand for a carbon material for catalyst support that exhibits superior permeability to gases and the like.

Furthermore, the manufacturing method described in the publication involves a phase separation reaction of silver acetylide that results in a large-scale explosion. This necessitates the use of reaction equipment with high strength and often leads to the need for larger reaction apparatuses.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a carbon material for catalyst support includes elongated carbon mesoporous structures containing graphene. The carbon mesoporous structures each have a major axis in a range of 50 nm to 200 nm and a minor axis in a range of 30 nm to 100 nm. Pore diameters and a cumulative pore volume determined through analysis of a nitrogen adsorption isotherm using a Dollimore-Heal method are respectively in a range of 1 nm to 20 nm and in a range of 1.5 cc/g to 2.5 cc/g.

With this configuration, the carbon material for catalyst support is composed of elongated, so-called bean-shaped carbon mesoporous structures containing graphene. The major axes of the carbon mesoporous structures are in a range of 50 nm to 200 nm, and the minor axes thereof are in a range of 30 nm to 100 nm. Thus, as compared with dendritic carbon mesoporous structures in a related art, gas or the like present in the pores readily moves to the outside. This shortens the retention time of gas and the like in the pores.

In addition, with the above-described configuration, the pore diameters are in a range of 1 nm to 20 nm, and the cumulative pore volume is in a range of 1.5 cc/g to 2.5 cc/g. Since the cumulative pore volume is larger than that in the related art, the permeability of gas and the like increases. Therefore, it is possible to provide a carbon material for catalyst support that has excellent permeability to gas and the like as well as a high electrical conductivity.

In another general aspect, a method for manufacturing a carbon material for catalyst support is provided. The method includes: preparing a solution containing silver or a silver salt; producing dendritic carbon nanostructures by introducing acetylene gas into the solution, the dendritic carbon nanostructures including silver acetylide and formed by branching rod-shaped bodies or annular bodies; producing carbon mesoporous structures incorporating silver by heating the dendritic carbon nanostructures in a water bath at a temperature higher than or equal to 80° C. to divide the dendritic carbon nanostructures into elongated carbon nanostructures, to generate ion pairs of cations of silver clusters and anions of carbon clusters, and to expand the elongated carbon nanostructures through heat generation caused by charge recombination of the ion pairs; and performing a heating treatment on the carbon mesoporous structures in a reduced pressure atmosphere or an inert gas atmosphere at a temperature in a range of 1600° C. to 2000° C. for a period in a range of 0.5 hours to 2.0 hours.

With this configuration, by heating the dendritic carbon nanostructures in a water bath at a temperature higher than or equal to 80° C., water of crystallization that stabilizes the shape of the carbon nanostructures is vaporized. When an external force that accompanies vaporization of the water of crystallization acts on the dendritic carbon nanostructures, the carbon nanostructures are divided into elongated carbon nanostructures.

Further, by heating the carbon nanostructures as described above, silver ions forming the carbon nanostructures grow into silver cluster cations, and carbon ions grow into carbon cluster anions covering the silver cluster cations. This generates ion pairs of the silver cluster cations and the carbon cluster anions. The elongated carbon nanostructures expand due to heat generation caused by charge recombination of these ion pairs, so that carbon mesoporous structures incorporating silver are produced. Specifically, at the time of charge recombination of ion pairs, positive charges and negative charges approach each other to become neutral charges. At this time, heat of about 2000° C. is locally generated by the movement of the electrons and holes. Due to this heat generation, carbon is converted into graphene, and carbon mesoporous structures in which carbon incorporates silver are produced.

Since silver ions and carbon ions become silver cluster cations and carbon cluster anions, the number of pairs of positive charges and negative charges is reduced, which reduces the risk of explosion. In the state of silver cluster cations and carbon cluster anions, silver acetylide does not explode on a large scale unless it reaches 200° C. This facilitates the handling of the silver acetylide at room temperature. However, although handling silver acetylide becomes easier at room temperature, it is important to note that attempting to produce approximately 100 g or more of the above-described carbon mesoporous structure can lead to a significant risk of a massive explosion due to a chain reaction of charge recombination occurring with heating to around 300° C.

In the carbon mesoporous structures produced in the above-described manner, the crystallinity of the graphene is low. With the above-described configuration, the carbon mesoporous structures are subjected to the heating treatment as described above, so as to increase the crystallinity of the graphene. In addition, the incorporated silver is sublimated and removed.

It is thus possible to facilitate the manufacture of a carbon material for catalyst support including elongated carbon mesoporous structures containing graphene.

Other features and aspects will be apparent from the following detailed description, the drawings, and the claims.

### BRIEF DESCRIPTION OF THE DRAWINGS

FIG. 1 is an SEM image of a carbon material for catalyst support according to one embodiment.

FIG. 2 is another SEM image of the carbon material for catalyst support of the embodiment shown in FIG. 1.

FIG. 3 is a TEM image of the carbon material for catalyst support of the embodiment shown in FIG. 1.

FIG. 4 is another TEM image of the carbon material for catalyst support of the embodiment shown in FIG. 1.

FIG. 5 is a flowchart showing a procedure for manufacturing the carbon material for catalyst support of the embodiment shown in FIG. 1.

FIG. 6 is an SEM image of mesoporous carbon nanodendrites in a related art as a comparative example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

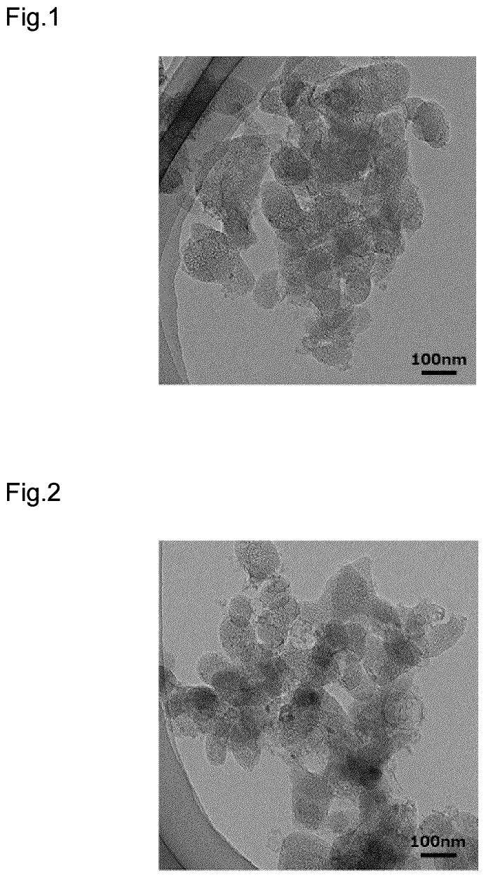

A carbon material for catalyst support and a method for manufacturing the carbon material for catalyst support according to one embodiment will now be described with reference to FIGS. 1 to 5.

As shown in FIGS. 1 to 4, the carbon material for catalyst support (hereinafter, referred to as carbon material) includes elongated carbon mesoporous structures containing graphene. The carbon material was named as Graphene Walled Carbon Nano-Sponge by the inventor of the present application.

The carbon mesoporous structures each have a major axis in a range of 50 nm to 200 nm and a minor axis in a range of 30 nm to 100 nm. The carbon mesoporous structures have so-called bean shapes.

The pore diameters of the carbon-mesoporous structures are in a range of 1 nm to 20 nm. The cumulative pore volume of the carbon material is in a range of 1.5 cc/g to 2.5 cc/g. The pore diameters and the cumulative pore volume are determined through analysis of a nitrogen adsorption isotherm using a Dollimore-Heal method.

The BET specific surface area of the carbon mesoporous structures is preferably in a range of 1500 m²/g to 1800 m²/g.

The micropore volume of pores having a diameter less than or equal to 2 nm in the carbon mesoporous structures, is preferably in a range of 0.80 cc/g to 0.95 cc/g.

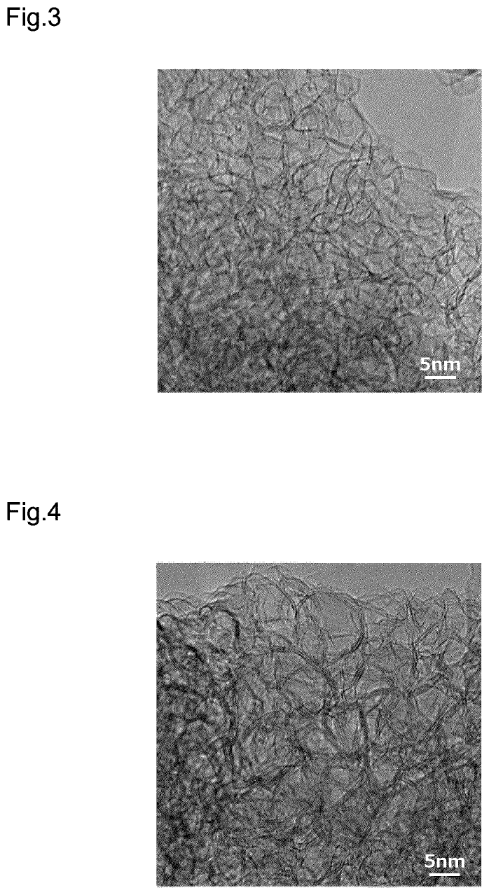

As shown in FIGS. 3 and 4, the carbon mesoporous structures are preferably mainly composed of graphene double-layer cavity walls. The carbon mesoporous structures include graphene triple-layer cavity walls and graphene quadruple-layer cavity walls.

The carbon material of the present embodiment can be used as, for example, a catalyst layer forming a single cell of a polymer electrolyte fuel cell. In this case, metal fine particles of catalyst such as platinum prepared to have a diameter of several nanometers are supported in a state of being dispersed in the pores in a highly dispersed state.

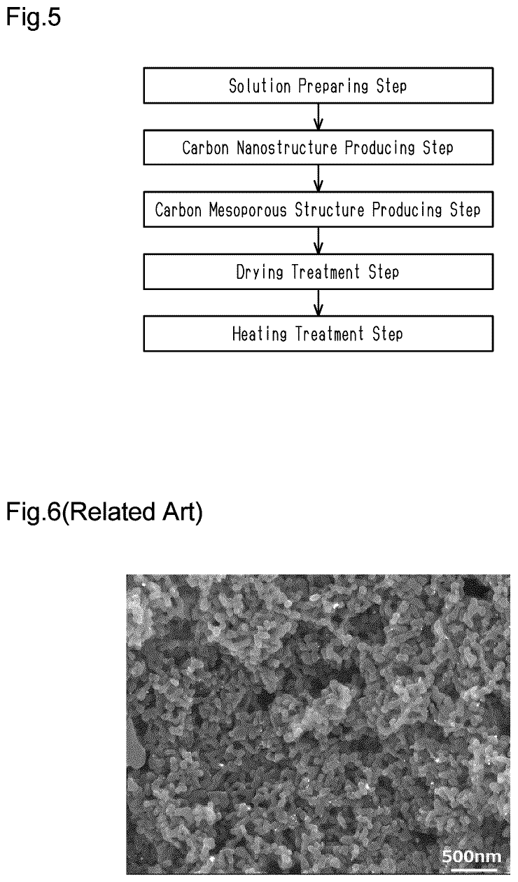

Next, a manufacturing procedure of the carbon material of the present embodiment will be described with reference to FIG. 5.

As shown in FIG. 5, the method for manufacturing the carbon material includes a solution preparing step, a carbon nanostructure producing step, a carbon mesoporous structure producing step, a drying treatment step, and a heating treatment step.

### Solution Preparing Step

The solution preparing step is a step for preparing a solution containing silver or a silver salt. In the present embodiment, an aqueous ammonia solution of silver nitrate is prepared as the solution.

### Carbon Nanostructure Producing Step

The carbon nanostructure producing step is a step for producing dendritic carbon nanostructures by introducing acetylene gas into the solution. The dendritic carbon nanostructures are composed of silver acetylide and formed by branching rod-shaped bodies or annular bodies.

### Carbon Mesoporous Structure Producing Step

The carbon mesoporous structure producing step is a step for producing carbon mesoporous structures incorporating silver by heating the dendritic carbon nanostructures in a water bath at a temperature higher than or equal to 80° C. In the present embodiment, the carbon nanostructures are heated in a water bath at a temperature of 100° C.

Specifically, by heating the dendritic carbon nanostructures in a water bath at a temperature higher than or equal to 80° C., water of crystallization that stabilizes the shape of the carbon nanostructures is vaporized. When an external force that accompanies vaporization of the water of crystallization acts on the dendritic carbon nanostructures, the carbon nanostructures are divided into elongated carbon nanostructures.

Further, by heating the carbon nanostructures as described above, silver ions forming the carbon nanostructures grow into silver cluster cations, and carbon ions grow into carbon cluster anions covering the silver cluster cations. This generates ion pairs of the silver cluster cations and the carbon cluster anions. The elongated carbon nanostructures expand due to heat generation caused by charge recombination of these ion pairs, so that carbon mesoporous structures incorporating silver are produced. Specifically, at the time of charge recombination of ion pairs, positive charges and negative charges approach each other to become neutral charges. At this time, heat of about 2000° C. is locally generated by the movement of the electrons and holes. Due to this heat generation, carbon is converted into graphene, and carbon mesoporous structures in which carbon incorporates silver are produced.

Since silver ions and carbon ions become silver cluster cations and carbon cluster anions, the number of pairs of positive charges and negative charges is reduced, which reduces the risk of explosion. In the state of silver cluster cations and carbon cluster anions, silver acetylide does not explode on a large scale unless it reaches 200° C. This facilitates the handling of the silver acetylide at room temperature. However, although handling silver acetylide becomes easier at room temperature, it is important to note that attempting to produce approximately 100 g or more of the above-described carbon mesoporous structure can lead to a significant risk of a massive explosion due to a chain reaction of charge recombination occurring with heating to around 300° C.

### Drying Treatment Step

The drying treatment step is a step for drying the above-described carbon mesoporous structures.

### Heat Treatment Step

The heating treatment step is a step for performing a heating treatment on the carbon mesoporous structures in a reduced pressure atmosphere or an inert gas atmosphere at a temperature in a range of 1600° C. to 2000° C. for a period in a range of 0.5 hours to 2.0 hours.

In the carbon mesoporous structures after the drying treatment step, the crystallinity of the graphene is low. In this regard, the carbon mesoporous structures are subjected to the heating treatment as described above, so as to increase the crystallinity of the graphene. In addition, the incorporated silver is sublimated and removed.

In the present embodiment, the heating treatment is performed at a temperature of 1800° C. using an electric furnace. Thereby, graphene double-layer cavity walls are mainly obtained. When the heating treatment temperature is higher than 1800° C., the ratio of the graphene triple-layer cavity walls and the graphene quadruple-layer cavity walls in the carbon mesoporous structures increases. As the ratio of the graphene triple-layer cavity walls and the graphene quadruple-layer cavity walls increases, the BET specific surface area of the carbon mesoporous structures decreases. On the other hand, as the ratio of the graphene triple-layer cavity walls and the graphene quadruple-layer cavity walls increases, the conductivity of the carbon mesoporous structures increases.

The carbon material is obtained by sequentially performing the steps described above.

Operation of the present embodiment will now be described.

The carbon material is composed of elongated, so-called bean-shaped carbon mesoporous structures containing graphene. The major axes of the carbon mesoporous structures are in a range of 50 nm to 200 nm, and the minor axes thereof are in a range of 30 nm to 100 nm. Thus, as compared with dendritic carbon mesoporous structures in a related art shown in FIG. 6, gas or the like present in the pores readily moves to the outside. This shortens the retention time of gas, ions, and the like in the pores (Operation 1).

In addition, the pore diameters are in a range of 1 nm to 20 nm, and the cumulative pore volume is in a range of 1.5 cc/g to 2.5 cc/g. Since the cumulative pore volume is larger than that in the related art, the permeability of gas, ions, and the like increases (Operation 2).

The present embodiment has the following advantages.
(1) Since the above-described operations 1 and 2 are achieved, it is possible to provide a carbon material for catalyst support that has excellent electrical conductivity and permeability to gas, ions, and the like.
(2) The micropore volume of pores having a diameter less than or equal to 2 nm in the carbon mesoporous structures, is in a range of 0.80 cc/g to 0.95 cc/g. As such, when the carbon material is employed in catalyst layers forming single cells of a polymer electrolyte fuel cell, pores of sizes less than or equal to 2 nm effectively function as reservoirs for temporarily storing protons. Thus, the protons can be efficiently brought into contact with or close to the catalyst.
(3) Since the BET specific surface area is in a range of 1500 m²/g to 1800 m²/g, the area on which catalyst is supported is increased. This allows a larger amount of metal fine particles of catalyst to be supported.
(4) Since the carbon mesoporous structures are mainly composed of graphene double-layer cavity walls, the BET specific surface area is larger than that in a case in which the carbon mesoporous structures are mainly composed of graphene triple-layer cavity walls. This increases the area on which the catalyst is supported, allowing a larger amount of catalyst to be supported.
(5) The method for manufacturing carbon material includes the solution preparing step, the carbon nanostructure producing step, the carbon mesoporous structure producing step, and the heating treatment step.

This configuration facilitates the manufacture of a carbon material for catalyst support including elongated carbon mesoporous structures containing graphene.

### Modifications

The above-described embodiment may be modified as follows. The above-described embodiment and the following modifications can be combined as long as the combined modifications remain technically consistent with each other.

The heating temperature in the carbon mesoporous structure producing step is not limited to 100° C. as long as it is higher than or equal to 80° C.

The BET specific surface area of the carbon mesoporous structures may be less than 1500 m²/g or greater than 1800 m²/g.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A carbon material for catalyst support, comprising elongated carbon mesoporous structures containing graphene, wherein
the carbon mesoporous structures each have a major axis in a range of 50 nm to 200 nm and a minor axis in a range of 30 nm to 100 nm, and
pore diameters and a cumulative pore volume determined through analysis of a nitrogen adsorption isotherm using a Dollimore-Heal method are respectively in a range of 1 nm to 20 nm and in a range of 1.5 cc/g to 2.5 cc/g.

2. The carbon material for catalyst support according to claim 1, wherein a micropore volume of pores having a diameter less than or equal to 2 nm in the carbon mesoporous structures is in a range of 0.80 cc/g to 0.95 cc/g.

3. The carbon material for catalyst support according to claim 1, wherein a BET specific surface area of the carbon mesoporous structures is in a range of 1500 m²/g to 1800 m²/g.

4. The carbon material for catalyst support according to claim 1, wherein the carbon mesoporous structures are mainly composed of graphene double-layer cavity walls.

5. A method for manufacturing a carbon material for catalyst support, the method comprising:
preparing a solution containing silver or a silver salt;
producing dendritic carbon nanostructures by introducing acetylene gas into the solution, the dendritic carbon nanostructures including silver acetylide and formed by branching rod-shaped bodies or annular bodies;
producing carbon mesoporous structures incorporating silver by heating the dendritic carbon nanostructures in a water bath at a temperature higher than or equal to 80° C. to divide the dendritic carbon nanostructures into elongated carbon nanostructures, to generate ion pairs of cations of silver clusters and anions of carbon clusters, and to expand the elongated carbon nanostructures through heat generation caused by charge recombination of the ion pairs; and
performing a heating treatment on the carbon mesoporous structures in a reduced pressure atmosphere or an inert gas atmosphere at a temperature in a range of 1600° C. to 2000° C. for a period in a range of 0.5 hours to 2.0 hours.
